(19) United States
(12) Patent Application Publication
(10) Pub. No.: US 2007/0037650 A1
(43) Pub. Date: Feb. 15, 2007

(54) ELECTRIC DRIVE APPARATUS

(75) Inventor: RALPH WESSELY, Burgthann (DE)

Correspondence Address: HENRY M FEIEREISEN, LLC, 350 FIFTH AVENUE, SUITE 4714, NEW YORK, NY, 10118, US

(73) Assignee: Demag Ergotech GmbH, Schwaig (DE)

(21) Appl. No.: 11/382,406

(22) Filed: May 9, 2006

(30) Foreign Application Priority Data
May 13, 2005 (DE) 10 2005 023 032.6

(51) Int. Cl. F16H 3/72

(52) U.S. Cl. 475/5

(57) ABSTRACT

An electric drive apparatus includes at least one electric motor having a rotor and at least two driven shafts which are disposed in coaxial relationship and driven at different rotation speed during operation of the electric motor. The driven shafts are constructed for separate connection to the rotor. Interposed between the rotor and at least one of the driven shafts is a gear mechanism in the absence of any direct interaction of the gear mechanism with the other one of the driven shafts.

### CROSS-REFERENCES TO RELATED APPLICATIONS

This application claims the priority of German Patent Application, Serial No. 10 2005 023 032.6, filed May 13, 2005, pursuant to 35 U.S.C. 119(a)-(d), the content of which is incorporated herein by reference.

### BACKGROUND OF THE INVENTION

The present invention relates, in general, to an electric drive apparatus.

Nothing in the following discussion of the state of the art is to be construed as an admission of prior art.

U.S. Pat. No. 5,463,914, issued on Nov. 7, 1995, discloses a multi-function power transmission mechanism having a plurality of miniature motors drawing little power. The motors are assembled together into a motor assembly to generate a relative large torque output, using a down-speed gear set, for application in electric appliances.

European Pat. Appl. No. EP 1 319 866 A1 describes a geared motor which includes a plurality of electric motors, each having an output shaft connected to a driving pinion. The driving pinions are arranged in symmetric relationship to a central drive wheel which is mounted on a gear shaft. The geared motor can be operated with two coaxial driven shafts, with some of the electric motors being coupled with a first gear shaft while the other electric motors are coupled with a second gear shaft. Thus, the geared motor can be used to operate two shafts independently from one another at different rotation speed and gear reduction. A drawback of this construction is the uneven load the geared motor assembly with the plural electric motors is subjected to because the electric motors are operated differently and independently from one another. Moreover, only a small torque output can be generated since the driven shafts are not individually acted upon by all electric motors. Several driven shafts require thus the use of a plurality of such geared motors to generate a large enough torque for the driven shafts.

It would therefore be desirable and advantageous to provide an improved electric drive apparatus which obviates prior art shortcomings and which is subjected to an even load during operation while still being compact and simple in structure as well as reliable in operation.

### SUMMARY OF THE INVENTION

According to one aspect of the present invention, an electric drive apparatus includes at least one electric motor having a rotor and at least two driven shafts disposed in coaxial relationship and driven at different rotation speed during operation of the electric motor, with the driven shafts constructed for separate connection to the rotor, and a gear mechanism interposed between the rotor and at least one of the driven shafts in the absence of any direct interaction of the gear mechanism with the other one of the driven shafts.

The present invention resolves prior art problems by providing an electric drive apparatus in which the at least two coaxial driven shafts can be operated at different rotation speed or different speed reduction/speed ratio, because at least one of the driven shafts is coupled to the rotor via an interposed gear mechanism while the other driven shaft remains unaffected by the gear mechanism. In other words, the gear mechanism provides the drive for only one driven shaft. By separating the linkage of the driven shafts, a misalignment between interacting shafts can also be effectively avoided. The coaxial guidance of the driven shafts which are coupled or can be coupled with the rotor or rotors, if several rotors are provided, generates an optimum torque output upon each driven shaft while the drive apparatus can be built compact in structure and subjected to even stress. The rotor(s) can thus act on all driven shafts so that the need for separate electric motors for the various driven shafts is eliminated. As a result, the number of necessary components for the electric drive apparatus is kept to a minimum so that the electric drive apparatus requires only little installation space.

According to another feature of the present invention, the electric motor may be constructed in the form of a hollow-shaft drive. Hollow-shaft drives can be designed in many ways and are compact while generating a large torque output, especially when a “high torque” construction is involved. They are useful especially in the field of injection molding machines and extruders and are commercially available as pre-fabricated assembly having a housing in which a stator is already fitted, and the rotor in the form of a hollow shaft is already mounted in the stator. Of course, components such as rotor and stator may be acquired also separately so as to allow installation of the rotor outside the stator for example. This increases design options and affords greater flexibility for applications.

While the one driven shaft is connected to the rotor via the gear mechanism, the other driven shaft may be connected to the rotor of the hollow-shaft drive, e.g. via a direct linkage in the absence of any interaction with the gear mechanism. By configuring the electric drive apparatus with a hollow-shaft drive, a compact construction can be realized.

According to another feature of the present invention, the gear mechanism may be a planetary gear train which is interposed between the one driven shaft and the rotor of the hollow-shaft drive. This allows a speed-down or speed-up of the hollow-shaft drive. Structure and operation of a planetary gear train are generally known to the artisan. The planetary gear train may include a planet wheel or planet wheels which may be received in the rotor in fixed relationship to the stator or may be received in a hollow shaft which is fixed to the rotor, with the planet wheel splined with the hollow shaft. As an alternative, the planet wheel(s) may also be rotatably mounted to a planetary carrier to rotate jointly with the planetary carrier about a common axis. It is also conceivable to hold the planetary carrier in place so as to transmit the torque via a sun wheel in engagement with the planet wheel(s). The planet wheel(s) of the planetary gear train may also be supported inside the rotor and, optionally, an interposed hollow shaft in fixed relationship to the stator of the hollow-shaft drive, for driving a gear, i.e. sun wheel, which is in engagement with the planet wheel(s) and operatively connected to the one driven shaft. In this way, the one driven shaft can be operated by the rotor at a different rotation speed than the other driven shaft.

According to another feature of the present invention, the electric drive apparatus may include a plurality of electric motors which are disposed in symmetric relationship to a center axis. The driven shafts may hereby be disposed in symmetric relationship to the center axis. Each electric motor has an output shaft which interacts with its rotor and is disposed in parallel relationship to the center axis. As a result, a compact drive is realized, whereby the driven shafts can be coupled or are coupled to all rotors of the electric motors. In other words, a driven shaft can be operated by all electric motors.

According to another feature of the present invention, a further gear mechanism may be operatively connected to the other driven shaft, wherein the gear mechanisms have different gear ratios and allow coupling of the output shafts to the driven shafts. In other words, each of the driven shafts is connected to its rotor via a separate gear mechanism which does not interact with the other driven shaft so that the driven shafts can be operated at different rotation speeds.

According to another feature of the present invention, the electric drive apparatus may include four electric motors which are disposed in symmetric relationship to a center axis in the corners of a square. As a result, the electric drive apparatus is compact and mutli-functional with a minimum of components and requires little installation space. Efficiency is high and operation of such a compact drive generates little noise during operation in view of the slight circumferential speed. As the torque output of the individual electric motors is combined, a large overall torque output is generated while at the same time realizing a high power density because the total torque output of the plurality of, e.g. four, electric motors is greater than the torque that can be generated by a single electric motor fitted in a housing of same dimensions. Through symmetric disposition of the individual electric motors about the coaxial driven shafts, there are no obstacles in the area along the driven shafts in the housing so that the driven shafts become easily accessible. This is especially true for a configuration of the electric drive apparatus with four electric motors that are disposed in the corners of an equilateral polygon, with the axis of the driven shafts forming the center point.

According to another feature of the present invention, the gear mechanisms may include driving pinions for respective forced engagement to the output shafts, and sun wheels for respective operative connection to the driven shafts. In other words, each driven shaft is operatively connected to its own gear mechanism, whereby the gear mechanisms have different gear ratio for allowing a coupling of all output shafts of the plurality of electric motors to the driven shafts. The driving pinions may have different diameters. Likewise, the sun wheels may have different diameters. Connection of all output shafts of the electric motors to the respective driven shafts results in even load distribution of the electric motors as well as shafts and gear mechanisms.

According to another feature of the present invention, at least one of the gear mechanisms may be of two-stage construction or multi-stage construction. For example, it is possible to connect driving pinions in pairs with two intermediate gears which are mounted on an intermediate shaft so that intermediate pinions connected to the intermediate shaft are able to engage the centrally disposed sun gear or driven gear of a driven shaft. In this way, the attainable torque can be increased by the factor 2 in comparison to conventional constructions.

According to another feature of the present invention, a single frequency converter may be provided for operating the driven shafts. The frequency converter can be used simultaneously by all individual motors, especially in the event of an assembly of several electric motors. Thus, there is no need to employ various frequency converters for operating the driven shafts, resulting in cost savings. In other words, it is possible to operate two driven shafts at different rotation speeds and different torques, using a single frequency converter only.

According to another feature of the present invention, at least one of the driven shafts may be constructed in the form of a hollow shaft. In this way, both driven shafts can extend out of the electric drive apparatus on one side and thereby ensure better accessibility. In this case, driving pinions which are forced into engagement with the motor shafts can be disposed in offset relationship on a common motor shaft and can have different diameters. Also when using a hollow-shaft drive, the arrangement of both driven shafts within one another may be conceivable, wherein one driven shaft may be connected directly to the rotor of the hollow-shaft drive while another driven shaft is rotatably supported in the hollow-shaft drive via a planetary gear train.

A driven shaft constructed in the form of a hollow shaft may be connected via a spindle nut with a threaded portion of the driven shaft whereas another portion of the driven shaft is operatively connected to a further gear mechanism for axial movement via a keyway profile. As a result, a driven shaft can be rotated as well as moved linearly so that the spatial dimension of the electric drive apparatus can be further reduced.

According to another feature of the present invention, the driven shafts may be disposed on different sides of the electric drive apparatus for force transmission. This may be appropriate for example for use of an electric drive apparatus according to the invention in hybrid injection units for injection molding thermoplastic materials, because such an electric drive apparatus can be used for implementing a plasticizing motion of a screw as well as providing a hydraulic pressure for the injection motion. As there is no axial misalignment between the two driven shafts, such a unit can be installed in a space-saving manner, and a modular exchangeability is simplified.

According to another feature of the present invention, the driven shafts may be disposed on a same side of the electric drive apparatus for force transmission. Another variation may involve the disposition of two driven shafts on one side while a third driven shaft may be disposed on the other side of the electric drive apparatus for force transmission. In the latter case, the one of the driven shafts on the same side may be designed in the form of a hollow shaft.

According to another feature of the present invention, at least one free-wheel may be disposed between one of the driven shafts and the rotor to thereby allow operation of the driven shaft solely in dependence on a rotation direction of the rotor. This is advantageous in situations when a torque should be generated in both directions along a driven shaft for example, whereas a torque upon the other driven shaft should be transmitted only in a particular direction.

According to another feature of the present invention, at least one free-wheel may be disposed between one of the driven shafts and a stationary housing. In this way, no torque is transmitted in a specific direction and at the same time the driven shaft that is not operated is prevented from uncontrollably spinning in relation to the housing. Thus, this driven shaft can, for example, be used for operating a plasticizing screw of a plasticizing and injection unit. To prevent a possible reversed rotation of such a plasticizing screw during an injection process, when the plasticizing screw stops rotating after plasticizing operation, a further free-wheel may be provided between the driven shaft and a fixed motor housing. The other driven shaft may for example engage a driveshaft of a pump or a spindle. The pump may be a variable capacity pump in four-quadrant operation that can be used to controllably draw or pump through, for example, a swivel disk with positive and negative pivot range, regardless of the rotation direction of the driveshaft. The pump does not convey, when the swivel disk is in zero position. Such a variable capacity pump may be provided, for example, in plasticizing and injection units for supply of injection cylinders and may be driven continuously during operation of the drive apparatus. When no pressure is required in the injection cylinder during operation of the drive apparatus, the swivel disk of the pump can be set to the zero position so that the pump is prevented from conveying. Such a pump is able to build up back pressure during plasticizing as well as application of an injection pressure or realizing a screw withdrawal, when the driveshaft rotates in opposite direction.

According to another feature of the present invention, the at least one freewheel may be constructed switchable, optionally like a switchable coupling. Suitably, the free-wheel is constructed for electric operation or magnetic operation. It is thus possible to tailor the torque transmission. For example, one driven shaft may be allowed to temporarily rotate in both directions until activating the free-wheel to bar a further torque transmission.

An electric drive apparatus according to the present invention can be utilized in many ways and is especially useful in areas that require generation of a large torque output. The electric drive apparatus is compact and evenly loaded as a result of the symmetric support of the driven shafts. No misalignment between the driven shafts exists so that the bearings and other load-bearing components are subjected to an even load as well.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a longitudinal section of one embodiment of an electric drive apparatus according to the present invention; and

FIG. 2 is a longitudinal section of another embodiment of an electric drive apparatus according to the present invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

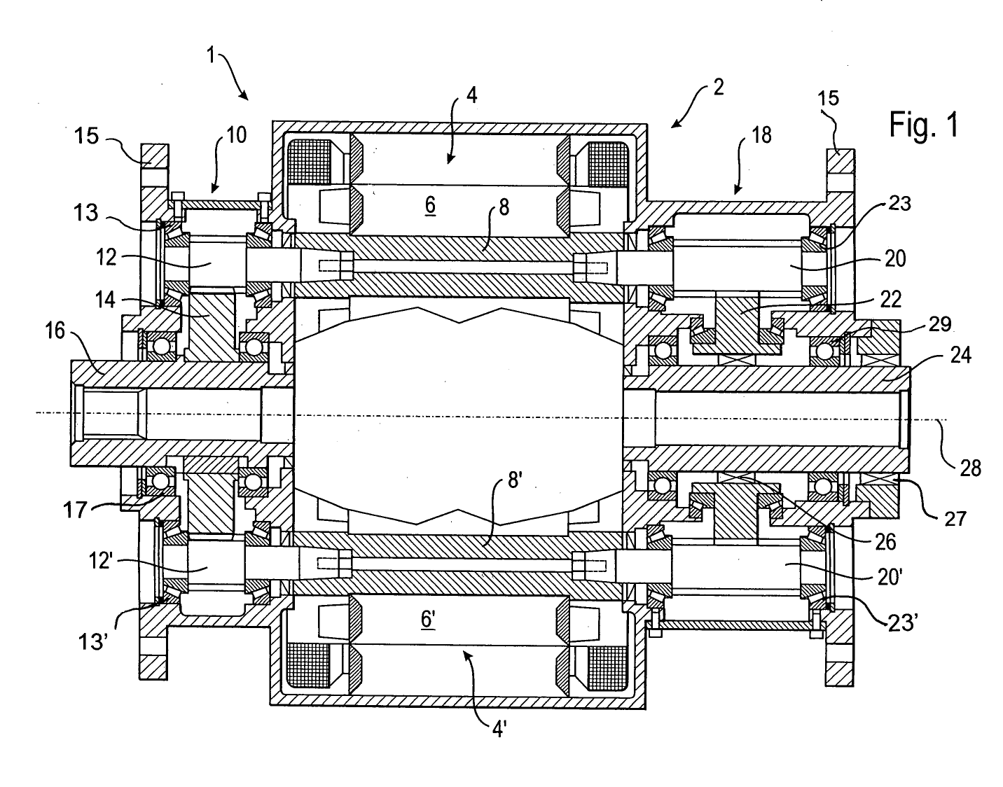

Turning now to the drawing, and in particular to FIG. 1, there is shown a longitudinal section of one embodiment of an electric drive apparatus according to the present invention, generally designated by reference numeral 1. The drive apparatus 1 defines a longitudinal center axis 28 and includes a compact drive 2 constructed along the center axis 28 and having electric motors 4, 4′ which are disposed in symmetric relationship to the center axis 28. Currently preferred is a configuration of four electric motors 4, 4′ (only two are visible in FIG. 1) which are disposed at the corners of a quadrant. Each electric motor 4, 4′ includes a rotor 6, 6′ rotatably mounted on a motor output shaft 8, 8′. The output shafts 8, 8′ can be coupled via gear mechanisms 10 and 18 with a first driven shaft 16 and a second driven shaft 24 which extend in coaxial relationship and are operatively connected to all rotors 6, 6′.

The gear mechanism 10 for transmitting a torque output by the rotors 6, 6′ to the driven shaft 16 includes driving pinions 12, 12′ which are operatively connected to the output shafts 8, 8′ and jointly engage a sun wheel 14 which is operatively connected to the driven shaft 16. The driving pinions 12, 12′ are supported by rolling-contact bearings 13, 13′ so as to be rotatable but immobile in axial direction. The driven shaft 16 is rotatably mounted to a housing 15 of the compact drive 2 by ball bearings 17 and, optionally, further unillustrated bearings. In order to realize a torque transmission between the driven shaft 16 and the driving pinions 12, 12′, the driven shaft 16 has an inside surface formed with a keyway profile for engagement in a spline profile of the drive pinions 12, 12′.

Although not shown in detail in FIG. 1, the driven shaft 16 may be operatively connected to a driveshaft of a pump or spindle.

The gear mechanism 18 is of similar configuration as the gear mechanism 10 and is disposed on an opposite side of the electric motors 4, 4′ than the gear mechanism 10. Of course, both gear mechanisms 10, 18 may also be disposed on a same side of the electric motors 4, 4′. In this case, one of the gear mechanisms 10, 18 may be operatively connected via a spindle nut (not shown) to one driven shaft which is constructed in the form of a hollow shaft and in engagement with a spindle shaft, while the other gear mechanism is connected via a spline profile with the other driven shaft received in this gear mechanism for axial movement.

The gear mechanism 18 for transmitting a torque output by the rotors 6, 6′ to the driven shaft 24 includes driving pinions 20, 20′ which are operatively connected to the motor shafts 8, 8′ and jointly engage a sun wheel 22 which is operatively connected to the driven shaft 24 via an interposed free-wheel 26. As a result, the torque output from the rotors 6, 6′ can act on the driven shaft 24 only for rotation of the driven shaft 24 in one rotation direction. It is thus conceivable to employ the driven shaft 24 for operating a plasticizing screw of a plasticizing and injection unit. To prevent a reversal in rotation of the driven shaft 24, a further free-wheel 27 is provided between the driven shaft 24 and the fixed housing 15.

Structure and operation of a free-wheel used in the electric drive apparatus according to the invention are generally known to the artisan so that a detailed description thereof is omitted for the sake of simplicity.

The driving pinions 20, 20′ are supported by rolling-contact bearings 23, 23′ so as to be rotatable but immobile in axial direction. Ball bearings 29 rotatably support the driven shaft 24 on the housing 15.

Although not shown in detail in FIG. 1, the compact drive 2 of the electric drive apparatus 1 includes a single frequency converter to transmit different torques onto the two driven shafts 16, 24 during operation of the compact drive 2.

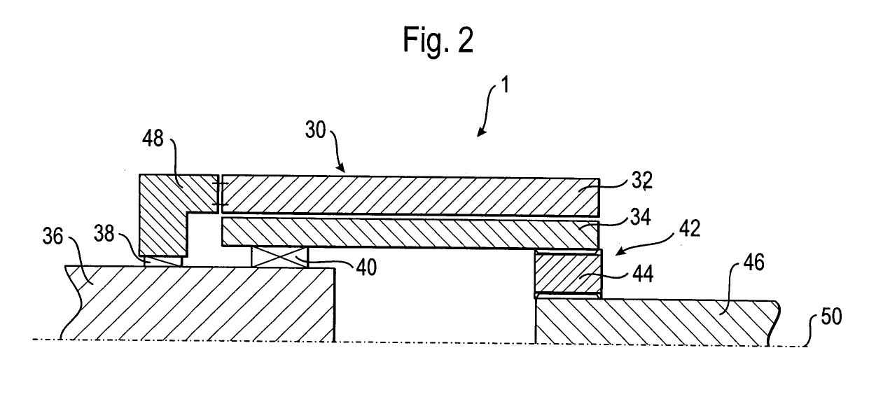

Referring now to FIG. 2, there is shown a longitudinal section of another embodiment of an electric drive apparatus according to the present invention, generally designated by reference numeral 11. The description below will center on the differences between the embodiments. In this embodiment, the electric drive apparatus 11 includes a hollow-shaft drive 30, shown only schematically. The hollow-shaft drive 30 includes stator 32 and is connected by a bearing cover 48. The stator 32 rotatably supports a rotor 34. Optionally, the rotor 34 may be connected on an inside to an additional hollow shaft (not shown) which is formed with internal teeth. A driven shaft 36 is connected to the rotor 34 of the hollow-shaft drive 30 via an interposed free-wheel 40 and supported for rotation about a center axis 50 in dependence on the rotation direction of the rotor 34. For sake of simplicity, the support of the driven shaft 36 is not shown in detail. A further free-wheel 38 is provided between the driven shaft 36 and the bearing cover 48 of the hollow-shaft drive 30. In this way, the driven shaft 36 is prevented from rotating in opposite direction in relation to the fixed stator 32, when the free-wheel 38 is activated. Such a configuration is advantageous, when connecting the driven shaft 36 to a plasticizing screw of a plasticizing and injection unit because a reversal in rotation of the plasticizing screw should be avoided after plasticizing of material has taken place.

Disposed opposite to the driven shaft 36 on the opposite side of the hollow-shaft drive 30 is a driven shaft 46 which is also supported for rotation about the center axis 50 and operatively connected to the rotor 34 via a gear mechanism 42 which is constructed in the form of a planetary gear train having planet wheels 44. The rotor 34 is hereby formed with internal teeth for engagement with the planet wheels 44 which in turn have respective teeth for operative engagement with the driven shaft 46. Of course, the connection between the planet wheels 44 and the driven shaft 46 may also be realized through intervention of a sun wheel (not shown). Although not shown in detail, the planet wheels 44 are rotatably supported via a planetary carrier (not shown) in fixed relationship to the stator 32.

Although not shown in detail in FIG. 2, the hollow-shaft drive 30 of the electric drive apparatus 11 includes also only a single frequency converter to transmit different torques onto the two driven shafts 36, 46 during operation of the hollow-shaft drive 30, whereby one of the driven shafts, here the driven shaft 46, rotates only in dependence on the rotation direction of the rotor 34 as a consequence of the interposed free-wheel 40.

Structure and operation of a free-wheel, such as free-wheels 26, 27, 38, 40, used in the electric drive apparatus according to the invention are generally known to the artisan so that a detailed description thereof is omitted for the sake of simplicity.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An electric drive apparatus, comprising:
at least one electric motor having a rotor and at least two driven shafts disposed in coaxial relationship and driven at different rotation speed during operation of the electric motor, said driven shafts constructed for separate connection to the rotor; and
a first gear mechanism interposed between the rotor and at least one of the driven shafts in the absence of any direct interaction of the first gear mechanism with the other one of the driven shafts.

2. The electric drive apparatus of claim 1, wherein the electric motor is a hollow-shaft drive.

3. The electric drive apparatus of claim 2, wherein the other driven shaft is directly coupled to the rotor of the hollow-shaft drive.

4. The electric drive apparatus of claim 2, wherein the first gear mechanism is a planetary gear train interposed between the one driven shaft and the rotor.

5. The electric drive apparatus of claim 4, wherein the hollow-shaft drive has a stator interacting with the rotor, said planetary gear train including a planet wheel received in the rotor in fixed relationship to the stator.

6. The electric drive apparatus of claim 1, wherein the driven shafts define an axis, further comprising a plurality of said electric motor disposed in symmetric relationship to the axis, with each electric motor having an output shaft in parallel relationship to the axis.

7. The electric drive apparatus of claim 1, wherein the driven shafts define an axis, further comprising four electric motors disposed in corners of a square for symmetric disposition of the electric motors in relationship to the axis.

8. The electric drive apparatus of claim 6, further comprising a second gear mechanism operatively connected to the other driven shaft, wherein the first and second gear mechanisms have different gear ratios and allow coupling of the output shafts to the driven shafts.

9. The electric drive apparatus of claim 8, wherein the first and second gear mechanisms include driving pinions for respective forced engagement to the output shafts, and sun wheels operatively connected to the driven shafts.

10. The electric drive apparatus of claim 8, wherein at least one of the first and second gear mechanisms is of two-stage construction.

11. The electric drive apparatus of claim 8, wherein at least one of the first and second gear mechanisms is of multi-stage construction.

12. The electric drive apparatus of claim 1, further comprising a single frequency converter for operating the driven shafts.

13. The electric drive apparatus of claim 1, wherein at least one of the driven shafts is constructed in the form of a hollow shaft.

14. The electric drive apparatus of claim 1, wherein the driven shafts are disposed on a same side of the electric drive apparatus for transmission of a force during operation.

15. The electric drive apparatus of claim 1, wherein the driven shafts are disposed on different sides of the electric drive apparatus for transmission of a force during operation.

16. The electric drive apparatus of claim 1, further comprising at least one free-wheel disposed between the other one of the driven shafts and the rotor to thereby allow operation of the other driven shaft solely in dependence on a rotation direction of the rotor.

17. The electric drive apparatus of claim 16, wherein the free-wheel is constructed for electric operation.

18. The electric drive apparatus of claim 16, wherein the free-wheel is constructed for magnetic operation.

19. The electric drive apparatus of claim 1, further comprising a housing, and at least one free-wheel disposed between one of the driven shafts and the housing.
